(19) United States
(12) Patent Application Publication
(10) Pub. No.: US 2025/0329758 A1
(43) Pub. Date: Oct. 23, 2025

(54) FUEL CELL OPERATING METHOD FOR REGENERATING A CATHODE CATALYST

(71) Applicant: Robert Bosch GmbH, Stuttgart (DE)

(72) Inventor: Helerson Kemmer, Vaihingen (DE)

(21) Appl. No.: 18/870,825

(22) PCT Filed: Jun. 19, 2023
(86) PCT No.: PCT/EP2023/066425

§ 371 Date: Dec. 2, 2024

(30) Foreign Application Priority Data
Jun. 22, 2022 (DE) 10 2022 206 244.2

(51) Int. Cl. H01M 8/04223; H01M 8/04746; H01M 8/10; H01M 8/1018

(52) U.S. Cl. CPC H01M 8/04231; H01M 8/04753; H01M 8/1018; H01M 2008/1095

(57) ABSTRACT

The invention relates to a method for operating a PEM fuel cell system having at least one fuel cell stack for regenerating a cathode catalyst of the fuel cell system as required, the method comprising the steps of: supplying the fuel cell system with hydrogen and oxygen in order to carry out a fuel cell process in a normal operating phase; continuously and/or repeatedly acquiring at least one operating parameter for evaluating performance of the fuel cell system; and initiating a temporary regeneration phase of the at least one fuel cell stack, consisting of: providing external electrical power for compensating for the electrical power of the relevant fuel cell stack; interrupting the supply to the relevant fuel cell stack of oxygen; introducing purge gas into a cathode portion of the relevant fuel cell stack; and, after a predetermined flushing time has elapsed, canceling the temporary regeneration phase in order to carry on the normal operating phase.

### BACKGROUND

The present invention relates to a method for operating a PEM fuel cell system having at least one fuel cell stack for regenerating a cathode catalyst of the fuel cell system as required, and to a fuel cell system.

Hydrogen-based fuel cells require hydrogen and oxygen or a gas mixture containing oxygen to carry out the fuel cell process. Waste heat generated by the fuel cells is usually dissipated using a cooling circuit and—when installed in a vehicle—released into the environment via a main vehicle radiator. For applications with high power requirements, such as buses and trucks, multiple fuel cell systems are usually used in parallel. Long, uninterrupted operation of fuel cells can lead to performance losses, which can be demonstrated by measuring various parameters on individual fuel cells. The performance losses are often reversible and can often be reversed by simple system measures. For example, platinum nanoparticles can oxidize on a cathode catalyst so that the reaction surface is reduced. This can be reversed by bleed-down of the cathode gas, i.e. switching off the oxygen supply while the fuel cell is in operation.

However, it is conceivable that oxidized platinum has penetrated deep into the cathode catalyst. If this is the case, oxygen depletion may be insufficient for regeneration and degradation of the relevant fuel cell could be permanent.

### SUMMARY

Therefore, it is the purpose of the invention to propose a process in which a cathode catalyst can be regenerated as required, even if oxidized platinum has already penetrated deep into the cathode catalyst.

The problem is solved by a method for operating a PEM fuel cell system with the features of the independent claim 1. Advantageous embodiments and further developments can be gathered from the dependent claims and the subsequent description.

The invention relates to a method for operating a PEM fuel cell system having at least one fuel cell stack for regenerating a cathode catalyst of the fuel cell system as required, the method comprising the steps of: supplying the fuel cell system with hydrogen and oxygen in order to carry out a fuel cell process in a normal operating phase; continuously and/or repeatedly acquiring at least one operating parameter for evaluating performance of the fuel cell system; and initiating a temporary regeneration phase of the at least one fuel cell stack, consisting of: providing external electrical power for compensating for the electrical power of the relevant fuel cell stack; interrupting the supply to the relevant fuel cell stack of oxygen; introducing purge gas into a cathode portion of the relevant fuel cell stack; and, after a predetermined flushing time has elapsed, canceling the temporary regeneration phase in order to carry on the normal operating phase.

The fuel cell system preferably comprises multiple fuel cells that are combined to form one or multiple fuel cell stacks. When used in commercial vehicles, it is particularly advantageous to use polymer electrolyte membrane (PEM) fuel cells. These are supplied with hydrogen or a gas containing hydrogen on the anode side and preferably with air on the cathode side. As mentioned at the beginning, several fuel cell stacks could be used flexibly in parallel to provide different outputs.

The fuel cell system is initially operated largely or temporarily stationary by supplying hydrogen and oxygen. This corresponds to a normal operating phase. Consequently, it is supplied with an adjustable volumetric flow of air and hydrogen so that the fuel cell process can take place. A current flow is required to maintain this process, for example through a corresponding electrical load.

During normal operation, operating parameters can be recorded, such as individual cell voltages, in order to assess performance. If, for example, an individual cell voltage drops by a certain amount or a certain percentage, for example 5% or more, from a nominal cell voltage, a regeneration phase can be initiated. The recording can be carried out in a time-controlled manner, for example after an interrupted operation of the relevant fuel cell stack for a certain period of time, for example 30 to 40 minutes. Alternatively, as mentioned above, a current voltage on the relevant fuel cell stack could be compared with a reference value, either at BOL (“begin of life”) or at BOD (“begin of drive”). If the deviation in performance is too great, e.g. 20%, the regeneration according to the invention is initiated. Another alternative is to compare the measured cell voltages, especially the worst value, with a reference value. Alternatively, an impedance value of the relevant fuel cell stack or of the cells can also be recorded. Alternatively, the regeneration according to the invention can also be initiated only when other processes, which relate purely to a bleed-down, for example, have not led to complete regeneration. This can be determined by a voltage deviation of at least 5% from the expected value.

In the regeneration phase, the power loss of the relevant fuel cell stack is initially compensated so that operation of the fuel cell system consumer can be maintained. This could include, for example, the operation of an additional fuel cell stack, the output of electrical power from a battery, or similar.

During normal operation, the supply of air or oxygen is interrupted at the same time, whereby the supply of hydrogen could be maintained for at least a short time during this process. In addition to the diffusion of hydrogen through the membrane to the cathode side, the supply of purge gas to the cathode side forces increased oxygen consumption and consequently a sharp drop in the cathode or cell potential. The reduction conditions on the cathode serve to break down the oxide deposits on the catalyst. This process is also known as “H2 soak”.

By at least partially maintaining the current flow, reductive conditions in the relevant fuel cell stack could be set more quickly. The lack of air intensifies the cleaning of the cathode catalyst by causing a voltage drop on the relevant fuel cells and is accompanied by a reduction in platinum oxides, which leads to an improvement in the active catalyst surface.

Once such a regeneration phase is complete, for example after a short flushing time of 1 s, 2 s, 3 s, or generally a few seconds, normal operation can continue. It is conceivable that such a regeneration phase is carried out regularly in order to maintain the performance of the fuel cell system.

In an advantageous embodiment, introducing purge gas into the cathode portion comprises feeding the purge gas into a cathode outlet. The effort required to integrate this function is low, as a conventional connection between a purge line and an exhaust air line downstream of a cathode shut-off valve can be modified so that the purge line is connected to an upstream side of a cathode shut-off valve.

In an advantageous embodiment, interrupting the supply of oxygen comprises opening a fuel cell bypass and closing a cathode shut-off valve, wherein the cathode shut-off valve is located downstream of the cathode outlet, and wherein the fuel cell bypass is connected to the cathode shut-off valve downstream thereof.

In an advantageous embodiment, the method further comprises closing a cathode inlet valve. This immediately results in oxygen depletion, which is further accelerated by introducing purge gas.

In an advantageous embodiment, the fuel cell system comprises a plurality of fuel cell stacks, wherein introducing purge gas comprises feeding purge gas of a first fuel cell stack into the cathode portion of a second fuel cell stack. The duration and strength of the purge with purge gas can therefore be controlled particularly easily, as the purge gas is obtained from an independent source.

In an advantageous embodiment, after canceling the temporary regeneration phase and a subsequent predetermined waiting period, the normal operating phase is resumed.

The invention also relates to a fuel cell system comprising at least one fuel cell stack having an anode and a cathode, a purge gas line connected to an anode outlet and having a valve arranged thereon, and a control unit, wherein the purge gas line can be connected to a cathode outlet of the at least one fuel cell stack, and wherein the control unit is coupled to the at least one fuel cell stack and to the valve arranged on the purge gas line and is designed to carry out the method according to the preceding description.

In an advantageous embodiment, the purge line is connected to a purge valve at an anode outlet of the fuel cell stack and to the cathode outlet of the same fuel cell stack.

In an advantageous embodiment, the purge line is connected to an anode outlet of a fuel cell stack and a purge transfer valve, wherein the purge transfer valve is connected to the cathode outlet of another fuel cell stack.

In an advantageous embodiment, the fuel cell system further comprises a purge valve for each fuel cell stack, wherein the respective purge valve is connected to an exhaust air line downstream of a cathode shut-off valve.

Further measures for improving the invention are described in greater detail hereinafter, together with the description of the preferred exemplary embodiments of the invention, with reference to the figures.

### BRIEF DESCRIPTION OF THE DRAWINGS

Shown are:

FIG. 1 a fuel cell system in a schematic illustration;

FIG. 2 a method for operating a fuel cell system in a block-based, schematic illustration;

FIG. 3 a schematic illustration of another fuel cell system;

FIG. 4 a further method for operating a fuel cell system in a block-based, schematic illustration.

### DETAILED DESCRIPTION

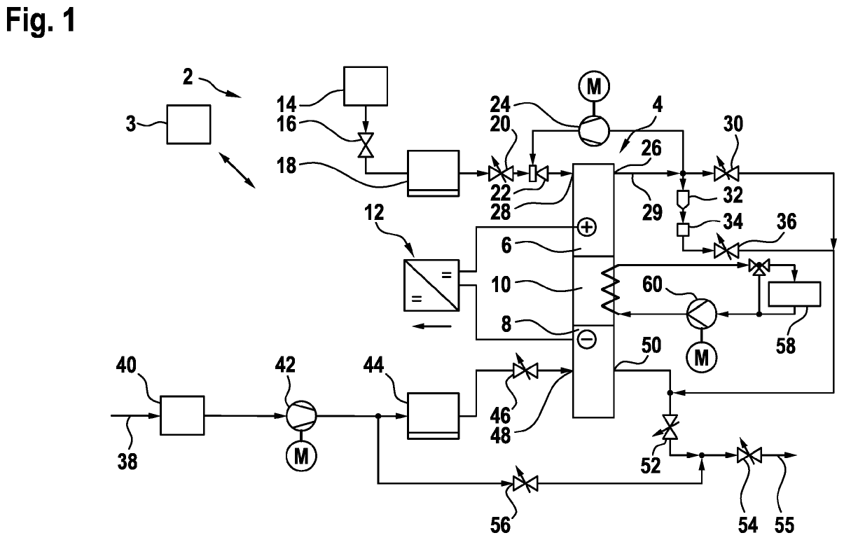

FIG. 1 shows a fuel cell system 2 in a schematic, block-based illustration. The fuel cell system 2 has a control unit 3 which is coupled to the functional components of the fuel cell system 2.

Furthermore, only a single fuel cell stack 4 is shown as an example, which comprises an anode 6 or an anode portion 6, a cathode 8 or a cathode portion 8 and a membrane not shown in detail here, as well as a heat exchanger 10 for dissipating heat. The anode portion 6 and the cathode portion 8 are only connected here by way of example to a DC/DC converter 12, which converts the voltage supplied by the fuel cell stack 4 to a desired level.

The anode 6 is supplied with hydrogen from a hydrogen tank 14, to which a hydrogen shut-off valve 16, a hydrogen heat exchanger 18, a hydrogen pressure regulator 20 and, by way of example, a jet pump 22 are connected. The jet pump 22 is connected to a compressor 24, which compresses residual anode gas from an anode outlet 26 and returns it to an anode inlet 28.

A line 29, a purge valve 30, a water separator 32 and a water tank 34 are connected to the anode outlet 26. The latter is connected to a drain valve 36, which can be opened as required to drain off water. Line 29 is used to conduct residual anode gases and to discharge purge gas. It is therefore also referred to as a purge gas line in the context of the invention.

The cathode 8 is supplied with air 38, which is filtered by an air filter 40 and compressed by an air compressor 42. This is followed by an air heat exchanger 44, which is connected upstream of a cathode inlet valve 46. Consequently, compressed, cooled air flows into the cathode inlet 48 and oxygen-enriched air flows out of a cathode outlet 50. This is followed by a cathode shut-off valve 52, which is followed further downstream by a pressure controller 54, via which exhaust air enters an exhaust air line 55 and finally into the environment. Air from the air compressor 42 can be fed directly to the pressure controller 54 via a fuel cell stack bypass 56 and discharged into the environment.

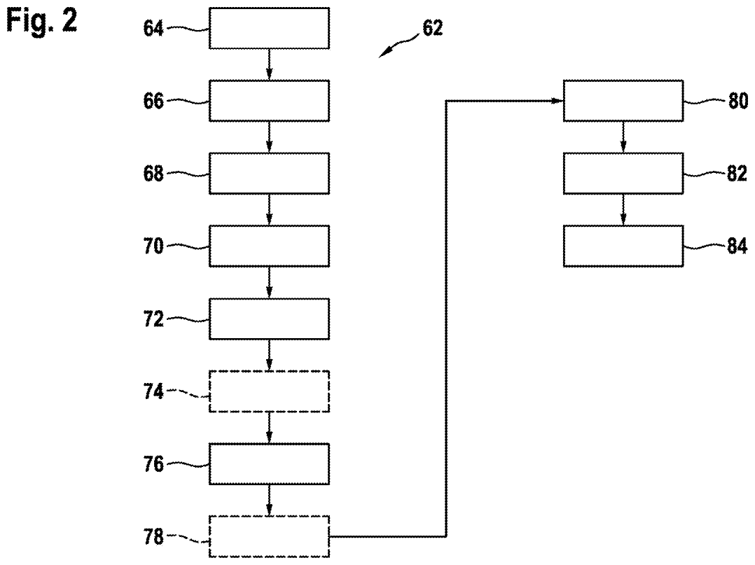

The purge valve 30 is connected here to the cathode outlet 50 in order to purge the cathode portion with hydrogen as required, controlled by the control unit 3, in order to regenerate one or more cathode catalysts. This is done using a process that is shown below in FIG. 2.

For the sake of completeness only, a vehicle radiator 58 is mentioned, which is coupled to the fuel cell heat exchanger 10 and circulates a coolant through the fuel cell heat exchanger 10 and the vehicle radiator 58 by means of a coolant pump 60.

FIG. 2 shows a method 62 which can be carried out by the control unit 3 for operating the fuel cell system 2 for regenerating the cathode catalyst as required. The method 62 first sets up the step of supplying the fuel cell system 2 with hydrogen and oxygen in order to carry out a fuel cell process in a normal operating phase, which is not shown in detail here. At least one operating parameter, for example a cell voltage, can be recorded 64 continuously and/or repeatedly to estimate the performance of the fuel cell system 2. If limited performance is detected, for example due to a deviation of a detected cell voltage from an expected cell voltage that is outside a tolerance, a temporary regeneration phase is initiated. This comprises providing 66 external electrical power for compensating the electrical power of the relevant fuel cell stack 4, interrupting 68 the supply of oxygen to the relevant fuel cell stack 4 by opening the fuel cell bypass 56 and the pressure controller 54 so that air from the air compressor 42 flows almost exclusively past the fuel cell stack 4. For example, the cathode shut-off valve 52 is closed 70. The purge valve 30 and/or the drain valve 36 are opened so that purge gas is introduced 72 into the cathode outlet 50. Optionally, the cathode inlet valve 52 can be closed 74. After the regeneration phase, the purge valve 30 and/or the drain valve 36 are opened again 76. Optionally, you can wait for a predetermined waiting time to expire 78. The provision 66 of external electrical power is interrupted 80, the cathode valves 46 and/or 52 are opened again 82 and normal operation of the fuel cell system 2 is carried on 84.

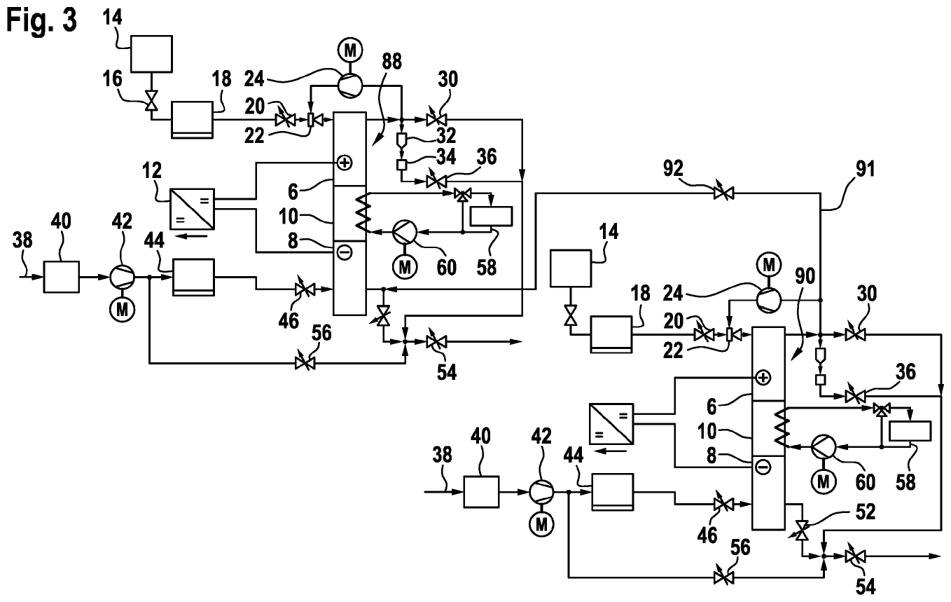

FIG. 3 shows a fuel cell system 86 with two fuel cell stacks 88 and 90 together with control unit 3 in a schematic view. Here, in contrast to the illustration in FIG. 1, purge gas is fed from the fuel cell stack 90 into the cathode outlet 50 of the fuel cell stack 88 in order to carry out a regeneration there. The purge valves 30 belonging to the two fuel cell stacks can be arranged downstream of the cathode shut-off valves 52, as is common in the prior art. Instead, a purge gas line 91 is provided, which leads to an additional purge transfer valve 92, which transfers the purge gases from one fuel cell stack 90 to the other fuel cell stack 88. The purge transfer valve 92 is connected to the anode outlet 26 of one fuel cell stack 90 and the cathode outlet 50 of the other fuel cell stack 88.

The fuel cell stack bypass 56 of the purged fuel cell stack 88 is open, as is its pressure controller 54. The air compressor 42 may be active.

The purge gas emitting fuel cell stack 90 can be operated in such a way that the hydrogen shut-off valve 16 is open, as is the hydrogen pressure regulator 20. However, the purge valve 30 is closed, as is the drain valve 36. The compressor 24 is in operation.

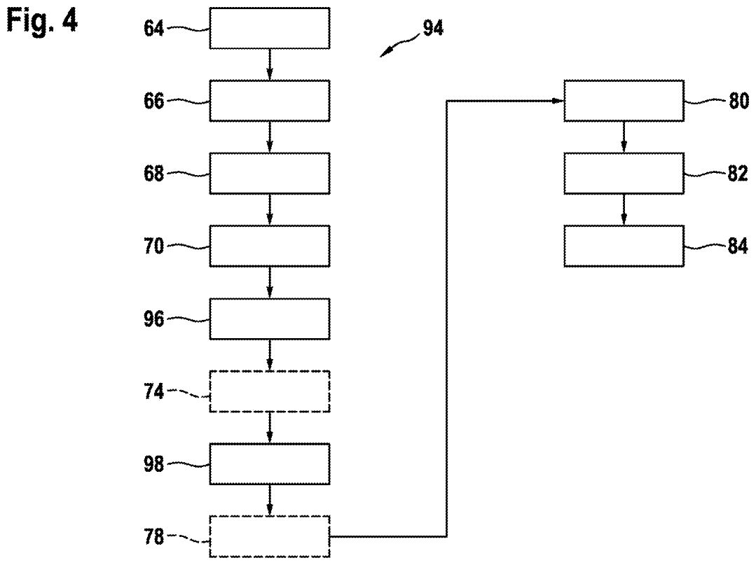

Finally, FIG. 4 shows a modified method 94 in which the purge transfer valve 92 is opened 96 instead of opening 72 of the purge valve and/or drain valve. Similarly, the purge transfer valve 92 is then closed 98.

1. A method (62, 94) for operating a PEM fuel cell system (2, 86) having at least one fuel cell stack (4, 88, 90) for regenerating a cathode catalyst of the fuel cell system (2, 86) as required, the method comprising the steps of:
supplying the fuel cell system (2, 86) with hydrogen and oxygen to carry out a fuel cell process in a normal operating phase;
continuously and/or repeatedly acquiring (64) at least one operating parameter for evaluating performance of the fuel cell system (2, 86);
and initiating a temporary regeneration phase of the at least one fuel cell stack (4, 88, 90), consisting of:
providing (66) external electrical power for compensating for the electrical power of the relevant fuel cell stack (4, 88, 90);
interrupting (68) the supply to the relevant fuel cell stack (4, 88, 90) of oxygen;
introducing (72) purge gas into a cathode portion (8) of the relevant fuel cell stack (4, 88, 90); and,
after a predetermined flushing time has elapsed, canceling the temporary regeneration phase to carry on (84) the normal operating phase.

2. The method (62, 94) according to claim 1,
wherein introducing (72) purge gas into the cathode portion (8) comprises supplying the purge gas into a cathode outlet (50).

3. The method (62, 94) according to claim 2,
wherein interrupting (68) the supply of oxygen comprises opening a fuel cell bypass (56) and closing a cathode shut-off valve (52),
wherein the cathode shut-off valve (52) is arranged downstream of the cathode outlet (50), and
wherein the fuel cell bypass (56) is connected downstream of the cathode shut-off valve (52).

4. The method (62, 94) according to claim 1,
further comprising the closing (74) of a cathode inlet valve (46).

5. The method (62, 94) according to claim 1,
wherein the fuel cell system (2, 86) has a plurality of fuel cell stacks (4, 88, 90), and
wherein introducing (72) purge gas comprises supplying purge gas of a first fuel cell stack (4, 88, 90) into the cathode portion of a second fuel cell stack (4, 88, 90).

6. The method (62, 94) according to claim 1,
wherein, after canceling the temporary regeneration phase and after a subsequent predetermined waiting period (78) has elapsed, the normal operating phase is carried on (84).

7. A fuel cell system (2, 86) comprising:
at least one fuel cell stack (4, 88, 90) having an anode portion (6) and a cathode portion (8),
a purge gas line (29, 91) connected to an anode outlet (26) with a valve (30, 36, 92) arranged thereon, and
a control unit (3),
wherein the purge gas line (29, 91) is connectable to a cathode outlet (50) of the at least one fuel cell stack (4, 88, 90), and
wherein the control unit (3) is coupled to the at least one fuel cell stack (4, 88, 90) and the valve (30, 36, 92) arranged on the purge gas line (29, 91) and is adapted to carry out the method (62, 94) according to claim 1.

8. The fuel cell system (2, 86) according to claim 7,
wherein the purge gas line (29, 91) is connected to a purge valve (30) at an anode outlet (26) of the fuel cell stack (4, 88, 90) and to the cathode outlet (50) of the same fuel cell stack (4, 88, 90).

9. The fuel cell system (2, 86) according to claim 7,
wherein the purge gas line (29, 91) is connected to an anode outlet (26) of a fuel cell stack (4, 88, 90) and a purge transfer valve (92), and
wherein the purge transfer valve (92) is connected to the cathode outlet (50) of another fuel cell stack (4, 88, 90).

10. The fuel cell system (2, 86) according to claim 9,
further comprising a purge valve (30) for each fuel cell stack (4, 88, 90), wherein the respective purge valve (30) is connected downstream of a cathode shut-off valve (52) to an exhaust air line (55).
